(19) United States
(12) Patent Application Publication
(10) Pub. No.: US 2012/0242927 A1
(43) Pub. Date: Sep. 27, 2012

(54) ACTIVE OPTICAL DEVICE AND DISPLAY APPARATUS INCLUDING THE SAME

(75) Inventors: Un-jeong Kim, Osan-si (KR); Sun-il Kim, Seoul (KR); Sang-jin Lee, Anyang-si (KR)

(73) Assignee: SAMSUNG ELECTRONICS CO., LTD., Suwon-si (KR)

(21) Appl. No.: 13/290,516

(22) Filed: Nov. 7, 2011

(30) Foreign Application Priority Data
Mar. 23, 2011 (KR) 10-2011-0025884

(51) Int. Cl. G02F 1/1335; G02F 1/1341

(52) U.S. Cl. 349/61; 349/84; 349/189

(57) ABSTRACT

An active optical device and a display apparatus are provided. The active optical device includes a graphene layer; a plurality of carbon nanotubes (CNTs) disposed on the graphene layer; a transparent electrode layer spaced apart from the plurality of CNTs; and a liquid crystal layer disposed between the graphene layer and the transparent electrode layer. The display apparatus includes a display unit for displaying at least one of two-dimensional (2D) and three-dimensional (3D) images; and the active optical device disposed on the display unit.

### CROSS-REFERENCE TO RELATED APPLICATION

This application claims priority from Korean Patent Application No. 10-2011-0025884, filed on Mar. 23, 2011 in the Korean Intellectual Property Office, the disclosure of which is incorporated herein in its entirety by reference.

### BACKGROUND

1. Field

Apparatuses and methods consistent with embodiments relate to active optical devices and display apparatus including the active optical devices.

2. Description of the Related Art

Passive optical devices such as lenses, mirrors, prisms, and the like may be variously used as components for changing an optical path in an optical system. In general, passive optical devices are formed of a material having a fixed refractive index and the change they impart to the optical path depends on their shape. Thus, many passive optical devices and complex structures are needed to control an optical path by using the passive optical devices in an optical system.

As a method of overcoming the complexity problem, active optical devices having refractive indexes which are controlled by an external signal have received considerable attention. As a typical active optical device, polymer-dispersed liquid crystal (PDLC) is used. A refractive index of liquid crystal material is changed according to a magnetic field applied to the PDLC, and thus, a difference in a refractive index between the liquid crystal and an adjacent polymer is generated so as to control an optical path passing therethrough.

### SUMMARY

According to an aspect of an exemplary embodiment, there is provided an active optical device including a graphene layer; a plurality of carbon nanotubes (CNTs) disposed on the graphene layer; a transparent electrode layer spaced apart from the plurality of CNTs; and a liquid crystal layer disposed between the graphene layer and the transparent electrode layer.

The active optical device may further include a plurality of catalyst portions disposed between the graphene layer and the plurality of CNTs.

The plurality of catalyst portions may be spaced apart from each other.

The graphene layer may include a plurality of sub graphene portions that are spaced apart from each other and correspond to the plurality of CNTs.

The graphene layer may include at least one graphene sheet.

The plurality of CNTs may be spaced apart from each other in the form of an array.

The CNT may include at least one of a single-walled carbon nanotube and a multi-walled carbon nanotube.

The active optical device may further include a first substrate disposed on a lower surface of the graphene layer, and a second substrate disposed on an upper surface of the transparent electrode layer.

At least one of the first substrate and the second substrate may be transparent.

The first substrate and the second substrate may be flexible.

Each of the first substrate and the second substrate may include at least one selected from the group consisting of glass, quartz, and plastic.

The active optical device may further include a plurality of spacers disposed between the graphene layer and the transparent electrode layer.

When a voltage is applied between the graphene layer and the transparent electrode layer, a refractive index of the liquid crystal layer may be changed.

When respective voltages are applied between the plurality of sub graphene portions and the transparent electrode layer, a refractive index of the liquid crystal layer may be partially changed.

According to an aspect of another exemplary embodiment, there is provided a display apparatus includes a display unit for displaying at least one of two-dimensional (2D) and three-dimensional (3D) images; and the active optical device described above disposed on the display unit.

### BRIEF DESCRIPTION OF THE DRAWINGS

The above and/or other aspects will become apparent and more readily appreciated from the following description of embodiments, taken in conjunction with the accompanying drawings of which:

FIG. 1A is a schematic plan view of an active optical device according to an exemplary embodiment;

FIG. 1B is a schematic cross-sectional view of an off state of the active optical device taken along a line AA′ of FIG. 1A, according to an exemplary embodiment;

FIG. 2 is a schematic cross-sectional view of an on state of an active optical device 100, according to an exemplary embodiment;

FIG. 3A is a schematic plan view of an active optical device according to an exemplary embodiment;

FIG. 3B is a schematic cross-sectional view of an off state of an active optical device taken along a line BB′ of FIG. 3A, according to an exemplary embodiment;

FIG. 4 is a schematic cross-sectional view of an on state of an active optical device, according to another exemplary embodiment;

FIG. 5 is a schematic cross-sectional view of an active optical device according to another exemplary embodiment; and

FIGS. 6A and 6B are schematic cross-sectional views of display apparatuses including active optical devices, according to exemplary embodiments.

### DETAILED DESCRIPTION

Various exemplary embodiments will now be described more fully with reference to the accompanying drawings.

Detailed illustrative exemplary embodiments are described herein. However, specific structural and functional details described herein are merely representative for purposes of describing exemplary embodiments. This invention may, however, may be embodied in many alternate forms and should not be construed as limited to only the exemplary embodiments set forth herein.

It should be understood, however, that there is no intent to limit exemplary embodiments to the particular forms disclosed, but on the contrary, exemplary embodiments are to cover all modifications, equivalents, and alternatives falling within the scope of the inventive concept. Like numbers refer to like elements throughout the description of the figures.

It will be understood that, although the terms ‘first’, ‘second’, etc. may be used herein to describe various elements, these elements should not be limited by these terms. These terms are only used to distinguish one element from another. For example, a first element could be termed a second element, and, similarly, a second element could be termed a first element, without departing from the scope of exemplary embodiments. As used herein, the term “and/or,” includes any and all combinations of one or more of the associated listed items.

It will be understood that when an element or layer is referred to as being “formed on,” another element or layer, it can be directly or indirectly formed on the other element or layer. That is, for example, intervening elements or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the drawings, the thicknesses of layers and regions may be exaggerated for clarity. Like reference numerals in the drawings denote like elements.

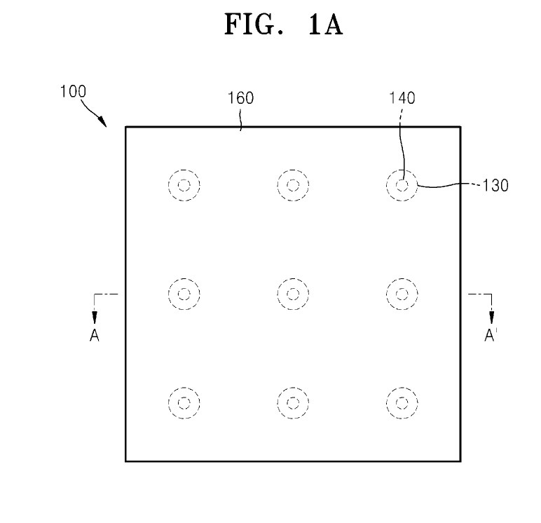

FIG. 1A is a schematic plan view of an active optical device 100 according to an embodiment. FIG. 1B is a schematic cross-sectional view of an off state of the active optical device 100 taken along a line AA′ of FIG. 1A, according to an embodiment.

Referring to FIGS. 1A and 1B, the active optical device 100 may include a graphene layer 120 and a plurality of carbon nanotubes (CNTs) 140 disposed on the graphene layer 120. The active optical device 100 may include a transparent electrode layer 170 spaced apart from the CNTs 140, and a liquid crystal layer 150 disposed between the graphene layer 120 and the transparent electrode layer 170. A first substrate 110 may be disposed below the graphene layer 120, and a second substrate 160 may be disposed above the transparent electrode layer 170.

The active optical device 100 may be a transmissive optical device. That is, light may be transmitted from the first substrate 110 towards the second substrate 160, or vice versa. Thus, the first substrate 110 and the second substrate 160 may be transparent and may be formed of, for example, glass, quartz, plastic, or the like. In addition, the first substrate 110 and the second substrate 160 may be flexible or stretchable. The first substrate 110 and the second substrate 160 may be spaced apart from each other and disposed parallel to each other, and liquid crystal may be filled therebetween.

The graphene layer 120 may be disposed on the first substrate 110 and may include at least one stacked graphene sheet. The graphene layer 120 may be formed on the first substrate 110 by using a chemical vapor deposition (CVD) method, a mechanical or chemical exfoliation method, an epitaxial growth method, or the like. In this case, graphene used to form the graphene layer 120 is a conductive material in which carbon atoms are arranged to have a 2D honeycombed lattice. Graphene is very stable from a structural and chemical point of view, is an excellent conductive material, has a greater charge mobility than silicon (Si), and a larger amount of current flows through graphene than copper (Cu). Graphene is provided in the form of a 2D sheet, and thus, may be referred to as a graphene sheet. The graphene sheet may be grown on a metal substrate formed of, for example, Cu, nickel (Ni), or the like by using a CVD method. In addition, the graphene layer 120 may be formed on the first substrate 110 by transferring the graphene sheet grown on the metal substrate by using Poly(methyl methacrylate) (PMMA), or the like.

Catalyst portions 130 may be further disposed between the graphene layer 120 and each of the CTNs 140. The catalyst portions 130 may facilitate growth of the CNTs 140 on the catalyst portions 130. The catalyst portions 130 may be formed of metal, for example, iron (Fe), aluminum (Al), Ni, an alloy thereof, or the like. The catalyst portions 130 are spaced apart from each other by predetermined intervals in the form of an array. The catalyst portions 130 may be formed by patterning the metal layer formed on the graphene layer 120 in the form of an array. For example, the catalyst portions 130 may be formed by forming the metal layer on the graphene layer 120 and then patterning the metal layer by using a photolithography process, an e-beam lithography method, or the like. In FIG. 1A, each of the catalyst portion 130 has a circular cross-sectional view, but is not limited thereto, and the each of the catalyst portions 130 may have a polygonal cross-sectional view. A thickness of the catalyst portions 130 may be several nanometers. For example, when the catalyst portions 130 are formed of Fe, the catalyst portions 130 may have a thickness of about 1 nm. When the catalyst portions 130 are formed of Al, the catalyst portions 130 may have a thickness of about 7 nm. When the catalyst portions 130 are formed of Ni, the catalyst portions 130 may have a thickness of about 5 nm. A size, that is, a diameter of the catalyst portions 130, may be several nanometers.

The CNTs 140 may include at least one of a single-walled carbon nanotube and a multi-walled carbon nanotube. The CNTs 140 may be grown on the respective catalyst portions 130 by using a CVD method or a plasma-enhanced chemical vapor deposition (PECVD) method. The CNTs 140 may be spaced apart from each other in the form of an array.

A height ‘h’ of the CNTs 140 may be proportional to the time taken to grow the CNTs 140 and may be several μm. In addition, the height ‘h’ of the CNTs 140 may be less than or equal to half of a distance ‘d’ by which the CNTs 140 are spaced apart from each other. The distance ‘d’ is about 10 μm, the height ‘h’ of the CNT 140 may be from about 1 to about 5 μm, for example, about 3 μm. A size, that is, a diameter of the CNTs 140, may be several nm and may be proportional to the size of the catalyst portions 130.

The active optical device 100 may include the graphene layer 120 and the CNTs 140. The graphene layer 120 may be used as an electrode. The active optical device 100 has an excellent transmissivity, compared to an optical device including a metal electrode, or a transparent electrode formed of indium tin oxide (ITO), ZnO, or the like. ITO may be dissolved at a high temperature, and ZnO may be easily etched by a carbon source. Thus, it is difficult to grow CNTs on a transparent electrode formed of ITO or ZnO. However, the graphene layer 120 and the CNTs 140 included in the active optical device 100 include sp2 carbons that are double-bonded, and thus, may be stable in a chemical process. Thus, the active optical device 100 may be stable in an etching process or a high-temperature CVD process, for example, a CVD process at a temperature from about 650° C. to about 700° C. In addition, when CNTs are grown by using a remote PECVD process such as a water-plasma process, a temperature for growing the CNTs may be lowered to about 450° C. Thus, an optical device may be formed on a substrate formed of inexpensive glass, quartz, plastic, or the like.

As an example of a method of manufacturing the graphene layer 120 and the CNTs 140, the CNTs 140 may be grown on the graphene layer 120 and then the CNTs 140 may be transferred onto the first substrate 110 with the CNTs 140. At first, a metal catalyst layer is formed on an auxiliary substrate, and a graphene sheet is grown on the metal catalyst layer. Then, a patterned catalyst portion is formed on the graphene sheet again, and the CNTs 140 are grown on the patterned catalyst portion. Then, the graphene layer 120 on which the CNTs 140 are disposed is coated with a coating material such as PMMA, or the like. The auxiliary substrate is removed from the graphene layer 120 by etching the metal catalyst layer below the graphene layer 120. The graphene layer 120 which is coated with PMMA is transferred onto the first substrate 110, and then the PMMA is removed by using a solvent such as acetone, or the like. The first substrate 110 may be flexible or stretchable.

The transparent electrode layer 170 may be disposed on a surface of the second substrate 160 facing the graphene layer 120 and may be formed of, for example, ITO, ZnO, or the like. The transparent electrode layer 170 may be spaced apart from the CNTs 140. The transparent electrode layer 170 may include at least one graphene sheet.

The liquid crystal layer 150 may be formed by filling liquid crystal between the first substrate 110 and the second substrate 160. When a voltage is not applied between the graphene layer 120 and the transparent electrode layer 170, that is, when the active optical device 100 is in an off state, liquid crystal molecules 155 included in the liquid crystal layer 150 may be uniformly arranged in a predetermined direction, as shown in FIG. 1B. In this case, the liquid crystal layer 150 may have a uniform refractive index distribution.

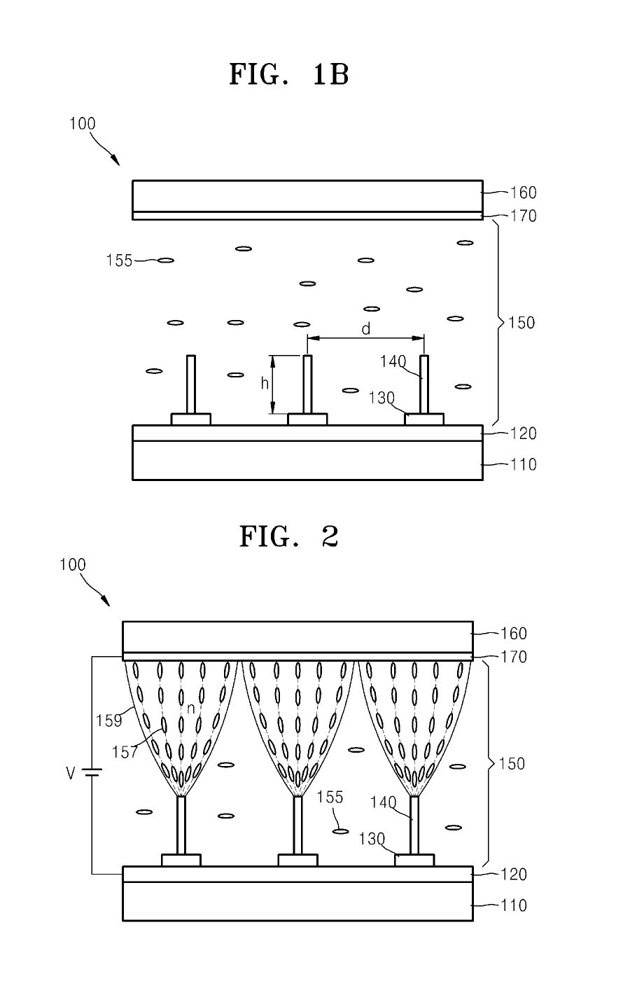

FIG. 2 is a schematic cross-sectional view of an on state of the active optical device 100, according to an exemplary embodiment.

Referring to FIG. 2, when a voltage (V) is applied between the graphene layer 120 and the transparent electrode layer 170, a 3D electric field may be formed in the liquid crystal layer 150, that is, between an end of the CNTs 140 and the transparent electrode layer 170. Along the 3D electric field, the arrangement of the liquid crystal molecules 157 may be changed. As the liquid crystal molecules 157 are rearranged, a refractive index of the liquid crystal layer 150 may change. In this case, the 3D electric field may be formed to have a cross-sectional view of a hemispherical shape similar to that of an inverse structure of a Gaussian distribution curve. The liquid crystal molecules 157 may be arranged according to the arrangement of the 3D electric field.

The liquid crystal molecules 157 included in an electric field region 159 may be rearranged, and the electric field region 159 of the liquid crystal layer 150 may have a refractive index of n. The electric field region 159 may function as an imaginary lens having a shape similar to that of a convex lens. An imaginary lens is formed with respect to each of the respective CNTs 140 that are arranged in the form of an array, and thus, the liquid crystal layer 150 may function as a lens array including a plurality of imaginary lenses.

Since the liquid crystal molecules 155 outside the 3D electric field regions 159 are not affected by the 3D electric field, the original arrangement of the liquid crystal molecules 155 may be maintained outside of the electric field regions. The liquid crystal layer 150, including the electric field regions 159 and a region outside the electric field regions 159, has an overall refractive index of n′. Thus, according to a voltage applied between the graphene layer 120 and the transparent electrode layer 170, on/off states of the active optical device 100 may be controlled. In addition, a refractive index of the active optical device 100 may be changed by controlling an amount of the applied voltage so as to change the arrangement of liquid molecules. In addition, when the refractive index of the active optical device 100 is changed, a focal distance of the active optical device 100 may be changed according to the changed refractive index.

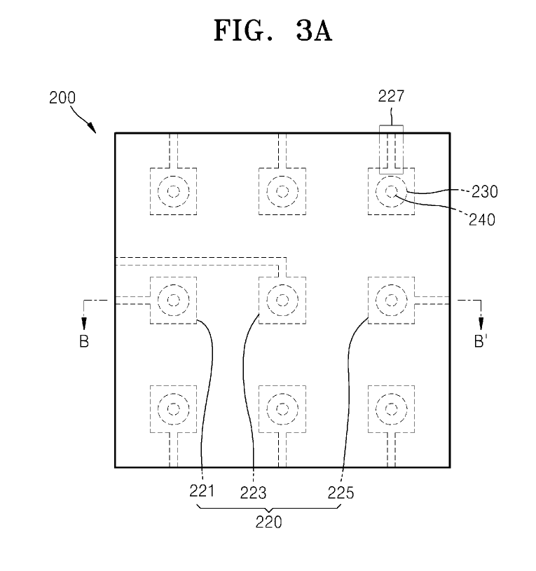

FIG. 3A is a schematic plan view of an active optical device 200 according to another exemplary embodiment. FIG. 3B is a schematic cross-sectional view of an off state of the active optical device 200 taken along a line BB′ of FIG. 3A. The active optical device 200 will be described in detail in terms of its differences from the active optical device 100 shown in FIGS. 1A and 1B.

Referring to FIGS. 3A and 3B, the active optical device 200 may include a graphene layer 220 and a plurality of CNTs 240 disposed on the graphene layer 220. The active optical device 200 may include a transparent electrode layer 270 spaced apart from the CNTs 240, and a liquid crystal layer 250 disposed between the graphene layer 220 and the transparent electrode layer 270. In addition, a first substrate 210 may be disposed on a lower surface of the graphene layer 220, and a second substrate 260 may be disposed on an upper surface of the transparent electrode layer 270.

The graphene layer 220 may be formed by patterning a graphene sheet in order to respectively apply voltages to the CNTs 240. That is, the graphene layer 220 may include a plurality of sub graphene portions 221, 223, and 225. The graphene layer 220 may be formed by patterning the graphene sheet by using, for example, a photolithography process, an e-beam lithography method, or the like. The sub graphene portions 221, 223, and 225 may be spaced apart from each other in the form of an array. The sub graphene portions 221, 223, and 225 may be respectively connected to patterned wires 227 formed by patterning the graphene sheet. Each of the sub graphene portions 221, 223, and 225 has a rectangular cross-sectional view, but may be patterned to have a circular cross-sectional view or another polygonal cross-sectional view. In FIG. 3A, the patterned graphene layer 220 and the sub graphene portions 221, 223, and 225 are exemplarily shown, but the patterns and the shapes of the sub graphene portions 221, 223, and 225 are not limited thereto. The sub graphene portions 221, 223, and 225 may be formed so as to be electrically insulated from each other in order to respectively apply voltages to the CNTs 240. The patterned wires 227 may be disposed on the first substrate 210 and may connect the sub graphene portions 221, 223, and 225 to external power sources. According to another exemplary embodiment, the patterned wires 227 may be formed in via holes formed through the first substrate 210. In this case, the sub graphene portions 221, 223, and 225 may be connected to the external power sources through the patterned wires 227 formed in the via holes.

The active optical device 200 may include a plurality of catalyst portions 230 that are formed on the graphene layer 220, that is, on the sub graphene portions 221, 223, and 225, respectively. The CNTs 240 may be grown on the catalyst portions 230, respectively. Catalyst portions 230 may facilitate growth of CNTs 240 on the catalyst portions 230. The catalyst portions 230 may be formed of metal, for example, Fe, Al, Ni, or the like. The catalyst portions 230 are spaced apart from each other by predetermined intervals in the form of an array. The catalyst portions 230 may be formed by forming a metal layer on the graphene layer 220 and then patterning the metal layer by using a photolithography process, an e-beam lithography method, or the like. In the active optical device 200, voltages may be applied between the sub graphene portions 221, 223, and 225, and the transparent electrode layer 270. In addition, different voltages may be applied between the sub graphene portions 221, 223, and 225, and the transparent electrode layer 270. That is, the respective different voltages may be applied between the CNTs 240 and the transparent electrode layer 270.

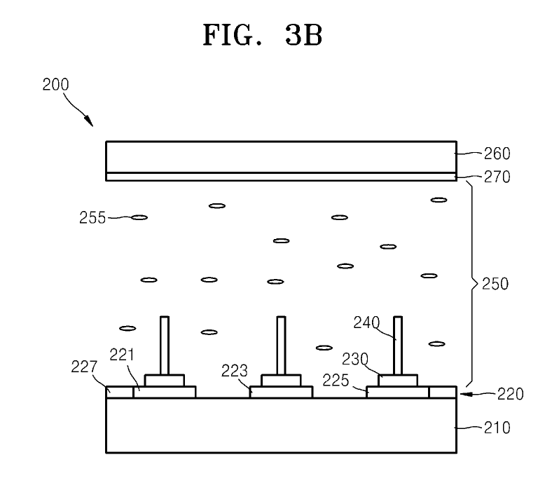

FIG. 4 is a schematic cross-sectional view of an on state of the active optical device 200, according to another exemplary embodiment.

Referring to FIG. 4, when different voltages V₁, V₂, and V₃ are applied between the sub graphene portions 221, 223, and 225, and the transparent electrode layer 270, respectively, a plurality of 3D electric fields may be formed in the liquid crystal layer 250, that is, between ends of CNTs 241, 243, and 245 and the transparent electrode layer 270. Along the 3D electric fields, the arrangement of liquid crystal molecules 257 may be changed. As the liquid crystal molecules 257 are rearranged, a refractive index of the liquid crystal layer 250 may be changed. In this case, each of the 3D electric fields may be formed to have a cross-sectional view of a hemispherical shape similar to that of an inverse structure of the Gaussian distribution curve. The liquid crystal molecules 257 may be arranged according to the arrangement of each of the 3D electric fields.

When the different voltages V₁, V₂, and V₃ are applied between the CNTs 241, 243, and 245, and the transparent electrode layer 270, an electric field distribution may be changed according to the different voltages V₁, V₂, and V₃. In addition, since the liquid crystal molecules 257 are rearranged according to the electric field distribution, refractive indexes of electric field regions 259, 251, and 253 may be adjusted. For example, when the voltage V₁ is applied to the CNT 241, the electric field region 259 of the liquid crystal layer 250 may have a refractive index of n₁ according to the changed arrangement of the liquid crystal molecules 257 in the electric field region 259. That is, the electric field region 259 may function as an imaginary lens having a shape similar to that of a convex lens.

When the voltages V₂ and V₃ are applied to the CNTs 243 and 245, respectively, the electric field regions 251 and 253 may have refractive indexes of n₂ and n₃, respectively, and may function as imaginary lenses. Since the CNTs 241, 243, and 245 that are arranged in the form of an array may each function as an imaginary lens, the liquid crystal layer 250 may function as a lens array including imaginary lenses. The lens array may change the refractive indexes of the electric field regions 259, 251, and 253 according to the amounts of the voltages V₁, V₂, and V₃ applied to the CNTs 241, 243, and 245. In addition, the electric field regions 259, 251, and 253 may adjust focal point distances of the imaginary lenses according to their refractive indexes. That is, the active optical device 200 may function as a lens array that has different focal point distances. For example, if the active optical device 200 is used in a 2D/3D integration image system, since a focal distance of an imaginary lens of each lens array is adjusted in proportion to a distance from a subject or a reproduced 3D image and then an image may be recorded and reproduced, image blurring may be prevented from occurring during an integration image method.

The active optical device 200 may control on/off states of the active optical device 200 according to a voltage applied between the graphene layer 220 and the transparent electrode layer 270. In addition, according to whether a voltage is applied to the CNTs 221, 223, and 225, the active optical device 200 may be partially switched on or off. By applying different voltages to the CNTs 221, 223, and 225 so as to obtain different arrangements of the liquid crystal molecules 257, the active optical device 200 may have different refractive indexes. When the refractive index of the active optical device 200 is partially changed, a focal distance of the active optical device 200 may be partially controlled according to the changed refractive index.

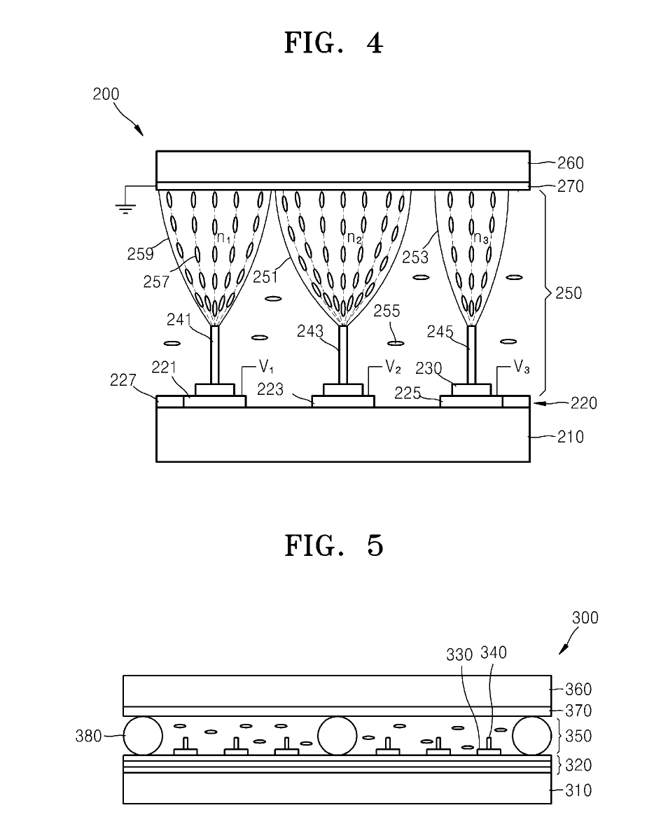

FIG. 5 is a schematic cross-sectional view of an active optical device 300 according to another exemplary embodiment. The active optical device 300 will be described in detail in terms of its differences from the active optical devices 100 and 200 according to the above-described embodiments.

Referring to FIG. 5, the active optical device 300 may include a graphene layer 320 and a plurality of CNTs 340 disposed on the graphene layer 320. The active optical device 300 may include a transparent electrode layer 370 spaced apart from the CNTs 340, and a liquid crystal layer 350 disposed between the graphene layer 320 and the transparent electrode layer 370. A first substrate 310 may be disposed below the graphene layer 320. A second substrate 360 may be disposed above the transparent electrode layer 370. The active optical device 300 may further include a plurality of catalyst portions 330 disposed on the graphene layer 320. The CNTs 340 may be disposed on the catalyst portions 330 that are spaced apart from each other, respectively. The active optical device 300 may further include a plurality of spacers 380 disposed between the graphene layer 320 and the transparent electrode layer 370.

The graphene layer 320 may include a plurality of graphene sheets. FIG. 5 shows the graphene layer 320 formed by stacking three graphene sheets. Since light transmittance of a graphene sheet is excellent, when three graphene sheets are stacked, light transmittance may be about 80% or more as compared to when a single graphene sheet is used.

The spacers 380 may be disposed between the first substrate 310 and the second substrate 360 so that the first substrate 310 and the second substrate 360 may be spaced apart from each other. In detail, the spacers 380 may be disposed between the graphene layer 320 and the transparent electrode layer 370. The spacers 380 may be spaced apart from each other by predetermined intervals in the form of an array on the graphene layer 320. A height of each spacer 380, that is, a distance between the graphene layer 320 and the transparent electrode layer 370 may be from about 10 μm to about 100 μm, for example, about 20 μm. As shown in FIG. 5, the spacer 380 may be formed to have a bead shape, but is not limited thereto.

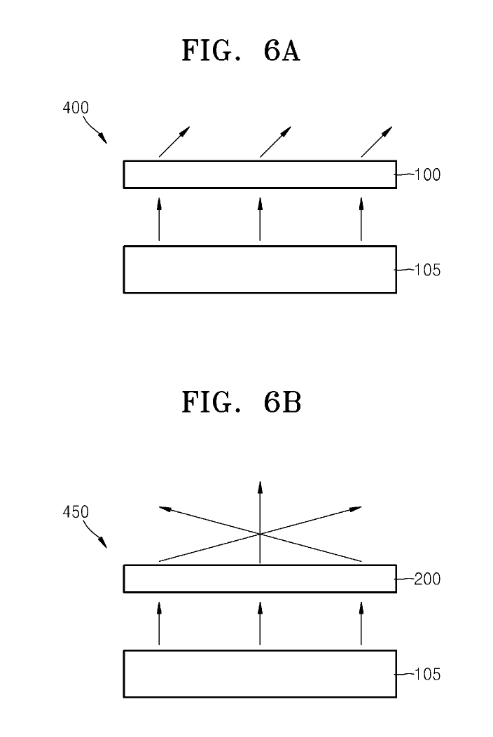

FIGS. 6A and 6B are schematic cross-sectional views of display apparatuses 400 and 450 respectively including the active optical devices 100 and 200, according to exemplary embodiments.

Referring to FIG. 6A, the display apparatus 400 may include a display unit 105 for displaying at least one of 2D and 3D images and the active optical device 100 disposed on the display unit 105.

The display unit 105 may display a 2D image, a 3D image, or may simultaneously display 2D and 3D images. The display unit 105 may include at least one of a light source and a display panel. The display unit 105 may further include a passive optical device such as a lens, a mirror, a prism, or the like.

A refractive index of the active optical device 100 may be controlled according to the amount of a voltage applied between the graphene layer 120 and the transparent electrode layer 170. Light emitted from the display unit 105 may be transmitted through the active optical device 100. The light transmitted through the active optical device 100 may be refracted in a predetermined direction according to the refractive index of the active optical device 100. Since the display apparatus 400 includes the active optical device 100 that is switched on or off according to an applied voltage, the display apparatus 400 may control the light emitted from the display unit 105.

Referring to FIG. 6B, the display apparatus 450 may include the display unit 105 for displaying at least one of 2D and 3D images and the active optical device 200 disposed on the display unit 105.

The display unit 105 may display a 2D image, a 3D image, or may simultaneously display 2D and 3D images. The display unit 105 may include at least one of a light source and a display panel. The display unit 105 may further include a passive optical device such as a lens, a mirror, a prism, or the like.

A refractive index of the active optical device 200 may be partially controlled according to the amount of a voltage applied between the sub graphene portions 221, 223, and 225, and the transparent electrode layer 270. Light emitted from the display unit 105 may be transmitted through the active optical device 200. The light emitted from the active optical device 200 may be refracted in a predetermined direction according to the refractive index of a corresponding portion of the active optical device 200. That is, light beams transmitted through different portions of the active optical device 200 may be refracted in different directions according to refractive indexes of the different portions of the active optical device 200. Since the display apparatus 450 includes the active optical device 200 having a refractive index partially changed according to voltages that are respectively applied to the sub graphene portions 221, 223, and 225 of the active optical device 200, the light emitted from the display unit 105 may be partially controlled.

It should be understood that the exemplary embodiments described herein should be considered in a descriptive sense only and not for purposes of limitation. Descriptions of features or aspects within each embodiment should typically be considered as available for other similar features or aspects in other embodiments. While exemplary embodiments have been particularly shown and described herein, it will be understood by one of ordinary skill in the art that various changes in form and details may be made therein without departing from the spirit and scope of the inventive concept as defined by the following claims.

What is claimed is:

1. An active optical device comprising:
a graphene layer;
a plurality of carbon nanotubes (CNTs) disposed on the graphene layer;
a transparent electrode layer spaced apart from the plurality of CNTs; and
a liquid crystal layer disposed between the graphene layer and the transparent electrode layer.

2. The active optical device of claim 1, further comprising a plurality of catalyst portions disposed between the graphene layer and the plurality of CNTs.

3. The active optical device of claim 2, wherein the plurality of catalyst portions are spaced apart from each other.

4. The active optical device of claim 1, wherein the graphene layer comprises a plurality of sub graphene portions that are spaced apart from each other in an array corresponding to the plurality of CNTs.

5. The active optical device of claim 1, wherein the graphene layer comprises at least one graphene sheet.

6. The active optical device of claim 1, wherein the plurality of CNTs are arranged in an array.

7. The active optical device of claim 1, wherein each of the plurality of CNTs comprises at least one of a single-walled carbon nanotube and a multi-walled carbon nanotube.

8. The active optical device of claim 1, further comprising a first substrate disposed on a lower surface of the graphene layer, and a second substrate disposed on an upper surface of the transparent electrode layer.

9. The active optical device of claim 8, wherein at least one of the first substrate and the second substrate is transparent.

10. The active optical device of claim 8, wherein the first substrate and the second substrate are flexible.

11. The active optical device of claim 8, wherein each of the first substrate and the second substrate comprises at least one selected from the group consisting of glass, quartz, and plastic.

12. The active optical device of claim 1, further comprising a plurality of spacers disposed between the graphene layer and the transparent electrode layer.

13. The active optical device of claim 1, wherein, when a voltage is applied between the graphene layer and the transparent electrode layer, a refractive index of the liquid crystal layer is changed.

14. The active optical device of claim 4, wherein, a respective voltage is applied between each of the plurality of sub graphene portions and the transparent electrode layer, a refractive index of the liquid crystal layer is partially changed.

15. A display apparatus comprising:
a display unit for displaying at least one of two-dimensional and three-dimensional images; and
the active optical device of claim 1 disposed on the display unit.

16. The display apparatus of claim 15, wherein the display unit comprises at least one of a light source and a display panel.

17. An active optical device comprising:
at least one graphene layer;
at least one carbon nanotube (CNT) disposed on the graphene layer;
a transparent electrode layer disposed above the at least one CNT;
a liquid crystal layer disposed between the at least one graphene layer and the transparent electrode layer and surrounding the at least one CNT.

18. A method of forming an active optical device, the method comprising:
providing an array of catalyst portions on a graphene layer;
growing a carbon nanotube (CNT) on each of the catalyst portions;
providing a transparent electrode layer on a substrate and providing the transparent electrode layer and substrate above the graphene layer such that the transparent electrode layer faces the CNTs;
filling liquid crystal around the CNTs between the graphene layer and the transparent electrode layer.

19. The method of claim 18, wherein the providing the array of catalyst portions comprises:
growing the graphene layer on a metal substrate, and patterning the metal substrate to form the array of catalyst portions.
